(19) United States
(12) Patent Application Publication
(10) Pub. No.: US 2012/0051874 A1
(43) Pub. Date: Mar. 1, 2012

(54) APPARATUS AND METHOD FOR SORTING WITH A MOVABLE HOLDING DEVICE

(75) Inventor: PETER BERDELLE-HILGE, KONSTANZ (DE)

(73) Assignee: SIEMENS AKTIENGESELLSCHAFT, MUENCHEN (DE)

(21) Appl. No.: 13/218,491

(22) Filed: Aug. 26, 2011

Related U.S. Application Data
(60) Provisional application No. 61/377,142, filed on Aug. 26, 2010.

(51) Int. Cl. B65G 49/00

(52) U.S. Cl. 414/222.01; 414/806

(57) ABSTRACT

An apparatus and method for sorting stackable articles according to a sort feature use a holding device with receiving units. The apparatus has a sorting system with a measuring instrument and a discharge device, a movable holding device and a plurality of receiving units. The holding device has a rack, preferably a running gear and a plurality of bays for respectively a receiving unit. The discharge device includes at least two discharge sites. Each receiving unit is capable of receiving a stack of articles. A bay is respectively assigned to each discharge site. The measuring instrument is capable of measuring for each article the value which the predefined sort feature assumes for the article. The discharge device selects a discharge site for each article and discharges the article into a receiving unit. The receiving unit is received by that bay of the holding device which is assigned to the selected receiving site.

### CROSS-REFERENCE TO RELATED APPLICATION

This application claims the benefit, under 35 U.S.C. §119(e), of provisional patent application No. 61/377,142, filed Aug. 26, 2010; the prior application is herewith incorporated by reference in its entirety.

### BACKGROUND OF THE INVENTION

### Field of the Invention

The invention relates to an apparatus and method for sorting stackable articles according to a sort feature, using a movable holding device having bays for receiving units.

An apparatus of the generic type and a method of the generic type are described in U.S. Pat. No. 6,183,191 B1.

U.S. Pat. No. 6,183,191 B1 describes a method and an apparatus for sorting flat articles, in particular mail items. A system (“mail cartridge system 10”) aligns flat mail items 30 by means of a jogger (“jogger 12”). A feed unit (“feeder 14”) generates a stack of flat mail items. A mobile and rotatable holding device (“turntable 16”) receives receiving units (“cartridges 20”) and can be moved to and fro between a first position and a second position, cf. FIG. 1. Such a receiving unit 20 receives a stack of upright, flat mail items and supports the stack by means of a movable supporting wall (“stack support panel 60”), cf. FIG. 14 to FIG. 18. The receiving unit 20 has a bottom and three side walls. In place of a fourth side wall, a gate in the form of a pivotable “drop gate 48” is present, so that, when the gate 48 is open, postal items can be pushed onto the receiving unit 20 and the gate 48 can then be closed.

The holding device 16 of U.S. Pat. No. 6,183,191 B1 interacts with an automatic handler (“mail cartridge handler 26”) having an “end effector 24”. The automatic handler 24, 26 obtains an empty receiving unit 20 from the holding device 16 and delivers a full receiving unit 20 to the holding device 16, cf. FIG. 2.

A succession of racks (“stacker modules 22a-22d”) respectively receives a plurality of receiving units 20, cf. FIG. 2. Each rack 22 offers, in the manner of a shelf unit, bays for a plurality of receiving units 20, cf. FIG. 10.

According to the description in U.S. Pat. No. 6,183,191 B1, a plurality of mail items are sorted in at least one sorting run according to a sorting plan. For each mail item, a destination receiving unit 20 (“destination cartridge”) is respectively selected in dependence on the sorting plan. In each receiving unit 20, a stack of vertically standing mail items is hereby respectively formed. The receiving units 20 here stand one above the other and side by side in components 23a to 23d, cf. FIG. 2 and FIG. 5 on the right. As soon as a receiving unit 20 is filled, the automatic handler 24, 26 replaces the full receiving unit 20 by an empty receiving unit 20, which the automatic handler 24, 26 removes from a rack 22, and conversely brings the full receiving unit 20 into the rack 22.

U.S. Pat. No. 6,026,967 describes a sorting system (“article handling system 10”) having a feed device (“autofeeder 50”), discharge device (“sorter 15”) and a matrix of output units (“array 19 of output compartments 20”) (cf. FIG. 1 of U.S. Pat. No. 6,026,967). The output units 20 are arranged in a plurality of rows and columns. Each output unit 20 is capable of receiving a specific receiving unit (“cartridge 25”). The sorting system 10 respectively generates in each container 25 a stack of flat mail items. FIG. 1 shows the sorting system 10 and a shelf unit (“buffer shelf 40”). The shelf unit 40 comprises a multiplicity of bays (“array of compartments 45”). Onto each bay 45 can respectively be placed a receiving unit 25. An automatic handler (“handling robot 30”) is capable of transporting receiving units 25 to and fro between the output units 20 of the sorting system and bays 45 of the shelf unit. In one embodiment, the shelf unit 40 possesses a running gear with rollers. The shelf unit 40 can therefore be moved to and fro between a receiving position and a delivery position. In the receiving position, the automatic handler 30 transfers filled receiving units 25 from an output unit 20 into a corresponding bay 45 of the shelf unit 40, cf. FIG. 11A to FIG. 11C. In the delivery position, filled receiving units 25 can be transferred from the shelf unit 40 to the feed device 50, cf. FIG. 11D to FIG. 11F.

United States Patent Application Publication US 2002/0070149 A1 describes a sorting system for several types of flat mail items. A sorting system 10 distributes mail items to output units (“bins”) in holding devices (“bin modules 22 and 24”). Each holding device respectively has two rows of receiving units. A plurality of holding devices 20, 22 can be connected to one another and released from one another in modular fashion. An “elevator module 20” distributes the mail items to the upper or to the lower row of receiving units of the holding device 22 by means of an “escalator” (“elevator 452”). Diverters distribute the horizontally transported mail items to the individual receiving units (“bins”) in the holding devices 22, 24. The “elevator module 20” is mobile, see FIG. 31-FIG. 33. The first holding device (“bin module 22”) has two rows of four receiving units (“mail bins 654”) each and is likewise mobile.

U.S. Pat. No. 7,547,174 B1 describes a method for removing a flat article from a “holder.” A rectangular rack (“case 700”) offers 16 bays in four rows of two columns each for respectively a container (“tray 730”), cf. FIG. 15. Mail items are sorted directly into these containers 730. This is realized by means of a plurality of “robots 100”. A multiplicity of robots 100 moves autonomously along a closed guide system (“track system 60”) comprising a plurality of rails (“trolley rails 62”, “power rail 64”). Each robot 100 is furnished with a mail item in a loading station 12 and transports this mail item to a berth in the rack 700.

European Patent EP 1049545 B1 describes a sorting system (“high output dispatch system”). There, each “dispatch subsystem 22” possesses a “transport mechanism 50” having a plurality of bays for containers. A “vertical lift 56” is capable of moving a bay with a container up and down, cf. FIG. 7. A further mechanism is capable of displacing a container by a “horizontal movement” into a holding device (“associated cart 52”). In the holding device 52, the container can be moved up and down.

### SUMMARY OF THE INVENTION

It is accordingly an object of the invention to provide an apparatus and device for sorting items by way of a mobile holding device which overcome the above-mentioned disadvantages of the heretofore-known devices and methods of this general type and which provides for a system that renders superfluous the step of having to transport a filled receiving unit from the discharge device to the holding device.

With the foregoing and other objects in view there is provided, in accordance with the invention, an apparatus for sorting stackable articles in accordance with a predefined sort feature, the apparatus comprising:

a sorting system including a measuring instrument and a discharge device, said discharge device having at least two discharge sites, said measuring instrument being configured to measure, for each of the stackable articles to be sorted, a value which the sort feature assumes for the article;

at least two receiving units;

at least one movable holding device including a rack and at least two bays each configured to receive a respective said receiving unit, and said holding device being movable into a discharge position with respect to said discharge device;

each said receiving unit being configured to receive a respective stack of articles to be sorted;

each said discharge site of said discharge device having a corresponding bay of each said holding device assigned thereto;

said discharge device being configured to select for each article to be sorted, in dependence on the sort feature value measured for the article, in each case precisely one said discharge site, and to respectively generate in each said receiving unit a stack of articles to be sorted;

said discharge device further being configured to then transport each article to be sorted to the selected discharge site and discharge the article from the selected discharge site directly into a given receiving unit, when said receiving unit, in the course of the discharge, is received by a bay of said holding device, with said holding device being in the discharge position, so that a stack of articles is respectively generated in each said receiving unit;

wherein said receiving bay is the corresponding said bay assigned to said discharge site selected by said discharge device for the respective article;

whereupon said holding device is transferred into the removal position such that said receiving units may be taken from said bays of said holding device located in the removal position.

In other words, the objects of the invention are achieved by an apparatus and a method that are are capable of sorting stackable articles. The articles are here sorted according to a predefined sort feature.

The apparatus includes, and the method employs:
a sorting system
at least one movable holding device and
at least two receiving units.

The sorting system comprises:
a measuring instrument and
a discharge device.

The discharge device possesses at least two discharge sites. The discharge device is capable of discharging into each receiving site articles to be sorted.

Each movable holding device comprises:
a rack and
at least two bays for receiving units.

Each receiving unit is designed respectively to receive a stack of articles to be sorted, after these articles have been discharged.

Each bay of the holding device is respectively capable of receiving a receiving unit for a stack of articles to be sorted, in particular by placement of the receiving unit onto the bay. This received receiving unit can be empty or filled with articles to be sorted, or can just now be filled.

To each discharge site of the discharge device there is respectively assigned a corresponding bay of each holding device.

Each holding device can be transferred into a discharge position with respect to the discharge device and removed again from this discharge position. Each holding device can also be transferred into a removal position.

The measuring instrument is designed to measure, for each article to be sorted, the value which the predefined sort feature assumes for this article.

The discharge device is designed to perform, for each article to be sorted, the following steps:

The discharge device selects a discharge site for the article. Which discharge site is selected depends on the value which the sort feature assumes for this article and which the measuring instrument has measured prior to the selection.

The discharge device transports each article to be sorted to that discharge site which has been selected for this article.

The article is transferred from this selected discharge site directly into a receiving unit. This receiving unit is received by a bay of a holding device. This holding device is in the discharge position with respect to the discharge device. This receiving unit into which the article is discharged is received by that corresponding bay which is assigned to that discharge site which the discharge device has selected for the article.

A stack of articles to be sorted is hence respectively generated in each receiving unit. Those articles for which the same discharge site has been selected are successively discharged into this receiving unit.

The fact that an article is discharged directly from the selected discharge site into this receiving unit onto the corresponding bay means that no intermediate step is performed in the transport of the article from the discharge site to the receiving unit. The article instead makes its way directly from the discharge site into or onto the receiving unit.

The assignment between respectively a discharge site and a bay of the holding device remains constant for a plurality of successive discharge operations. However, it is possible to use for each discharge operation other receiving units. This makes it possible to perform the two operations in chronological overlap, to further treat the filled receiving units after their removal from the holding device, and to transfer the holding device with other, still empty receiving units back into the discharge position and perform a subsequent further discharge operation.

In other words: the discharge device selects a discharge site for an article. To this selected discharge site there is respectively assigned a bay of each holding device. The bay thereby becomes the corresponding bay. This bay receives a receiving unit. A holding device with the bay and the received receiving unit is in the discharge position with respect to the discharge device. The discharge device discharges the article into this receiving unit.

Next, the holding device is transferred from the discharge position into a removal position. In this removal position, the receiving units can be taken from the bays of the holding device.

The invention eliminates the step of taking an empty receiving unit from a bay outside the sorting system and transferring the empty receiving unit into a position with respect to the discharge device in which the discharge device is capable of generating a stack of articles in the receiving unit. Instead, according to the solution, empty receiving units are transported on the bays of the holding device to the discharge device as the holding device is transferred into the discharge position.

In particular, the step in which a worker or an automatic handler transports a single receiving unit to and fro between the holding device and the sorting system is spared. The sparing of this step means that the invention saves time for this transfer, as well as the cost, for example, of an automatic handler. The danger of a receiving unit falling to the ground during this transport and hereby damaging the receiving unit, and/or of articles to be sorted being damaged in the receiving unit, is reduced. This danger is markedly reduced if all receiving units are located in the holding device and are moved together with the holding device.

The invention further eliminates the step of transporting away from the discharge device a single receiving unit filled with discharged articles, and of putting it into the holding device. Instead, the entire holding device, with all unfilled, fully or partially filled receiving units, is transferred all at once from the discharge position into the removal position.

The invention saves on bays outside the movable holding device. In particular, it is not necessary to respectively provide a bay for each receiving unit in a shelf and a further bay in the discharge device itself. Instead, one bay per receiving unit in the movable holding device is sufficient. This one bay can be used both for transporting an empty receiving unit to the discharge device and for transporting away the receiving units filled with articles. In addition, this bay receives a receiving unit in the course of the sorting and discharging. In this received receiving unit, articles can be discharged. In particular, the apparatus according to the solution thereby saves on floor space (“footprint”).

The apparatus according to the solution makes do without a conveyor belt and without a similar transporting device for receiving units. Instead, the movable holding device acts both as a mounting and high-bay racking and as a transporting device for receiving units.

The apparatus according to the solution increases the throughput through the sorting system. The holding device with filled receiving units is transported away from the sorting system, the receiving units are removed, empty receiving units are loaded in, and the holding device with empty receiving units is transferred back into the discharge position. The steps of supplying empty receiving units and removing filled receiving units can be performed in chronological overlap, even substantially in parallel and in a single step.

According to the solution, an article is transported from the selected discharge site directly into the receiving unit onto the corresponding bay. The discharge site then acts as a coupling point (“interface”) between the sorting system with the discharge device and the holding device with the bays and the receiving units on the bays, when the holding device is in the discharge position. The coupling point no longer exists once the holding device with the receiving units is being transferred, or is already transferred, into the removal position.

Preferably, the at least two bays are placed vertically or obliquely one above the other. This embodiment saves still more on floor space (“footprint”).

Preferably, an article is transferred by a linear movement from the selected discharge site to the receiving unit on the corresponding bay. The discharge sites, bays and receiving units are designed such that this is enabled. The linear movement is, for example, a horizontal linear movement. The apparatus is designed such that a receiving unit on a corresponding bay is located at roughly the same height and width as the discharge site selected by an article. The linear movement can also lead, for example, obliquely or vertically downward. Due to gravity, an article slides from the selected discharge site into the receiving unit onto the corresponding bay.

Preferably, each receiving unit is locked on a bay of a holding device by means of a receiving unit locking mechanism. The locking connection between bay and receiving unit is preferably established when the empty receiving unit is placed onto the bay and before the holding device is transferred into the discharge position. After sorting and discharging, the locking connection is released again when the filled receiving unit is taken from the bay and preferably after the holding device has been transported away from the discharge position. This embodiment prevents the receiving unit from changing its position relative to the movable holding device as the discharge device discharges articles into this receiving unit. A change of position could lead to a jam or some other disturbance. In addition, the receiving unit is prevented from falling out of the holding device as the holding device is transported.

Often the weight of the holding device with the receiving units is already sufficient to hold the holding device in a desired discharge position with respect to the discharge device. In one embodiment, on the other hand, a holding device locking mechanism additionally secures the holding device in the discharge position. The holding device locking mechanism establishes a locking connection between the holding device and the sorting system when the holding device is in the discharge position. As soon as the locking connection is established, the holding device is held in the discharge position. Preferably, the holding device with the empty receiving units is transported to the sorting system and then releasably locked by means of the holding device locking mechanism.

Preferably, at least one holding device is configured as a mobile holding device. The rack of this mobile holding device has a running gear. The holding device can hence be transported over a floor. As a result of this transport, the mobile holding device can be transferred into the discharge position with respect to the discharge device and from the discharge position into the removal position. This embodiment saves the step of the holding device having to be carried and held by the sorting system or by a further device, and having to be movably connected to the sorting system or the further device. A worker or an automatic handler is also spared from having to carry the holding device.

It is also possible for the holding device to be movable and be moved in some other way with respect to the fixed discharge device in order to move the holding device into the discharge position and move it away from the discharge position.

It is possible for the running gear additionally to be locked, for example with a fixing brake.

Preferably, two holding devices having respectively at least two bays for receiving units are used. A first holding device is moved to the discharge device and transferred into the discharge position. Next, the discharge device fills the previously empty receiving units on the bays of this first holding device. The first holding device with the filled receiving units is then transferred from the discharge position into the removal position.

In parallel or in chronological overlap with the step of discharging articles into the receiving units of the first holding device, a second holding device is filled with empty receiving units, and the second holding device with the empty receiving units is transferred into the discharge position as soon as the first holding device has been transferred away from the discharge position. This embodiment allows a chronologically overlapping use of two holding devices for the same sorting system and saves time, since very little time is required to replace the full receiving units by empty receiving units.

The invention can be used, for example, to sort flat items of mail, paper sheets, banknotes, banker's cards or other stackable articles.

Other features which are considered as characteristic for the invention are set forth in the appended claims.

Although the invention is illustrated and described herein as embodied in an apparatus and method for sorting by means of a movable holding device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a top view of the apparatus according to an exemplary embodiment with a sorting system and a holding device;

FIG. 2 is a front view of the discharge sites of the sorting system of FIG. 1;

FIG. 3 shows the apparatus of FIG. 1 in side view with the holding device in the discharge position;

FIG. 4 shows the apparatus of FIG. 3 with the holding device outside the discharge position and with a further holding device in the discharge position; and

FIG. 5 shows a bay with a receiving unit locking mechanism and a sorting end position with a discharge locking mechanism.

### DETAILED DESCRIPTION OF THE INVENTION

In the exemplary embodiment, the apparatus to sort flat items of mail (standard letters, large-sized letters, postcards, catalogues, and the like) is used. Each mail item is provided with respectively an identification of an addressee of this mail item. This addressee identification states the destination address to which this mail item is to be transported. In the exemplary embodiment, these addressee identifications act as the sort feature according to which the mail items are to be sorted.

In the exemplary embodiment, the apparatus comprises:
a sorting system,
a plurality of receiving units,
at least two holding devices.

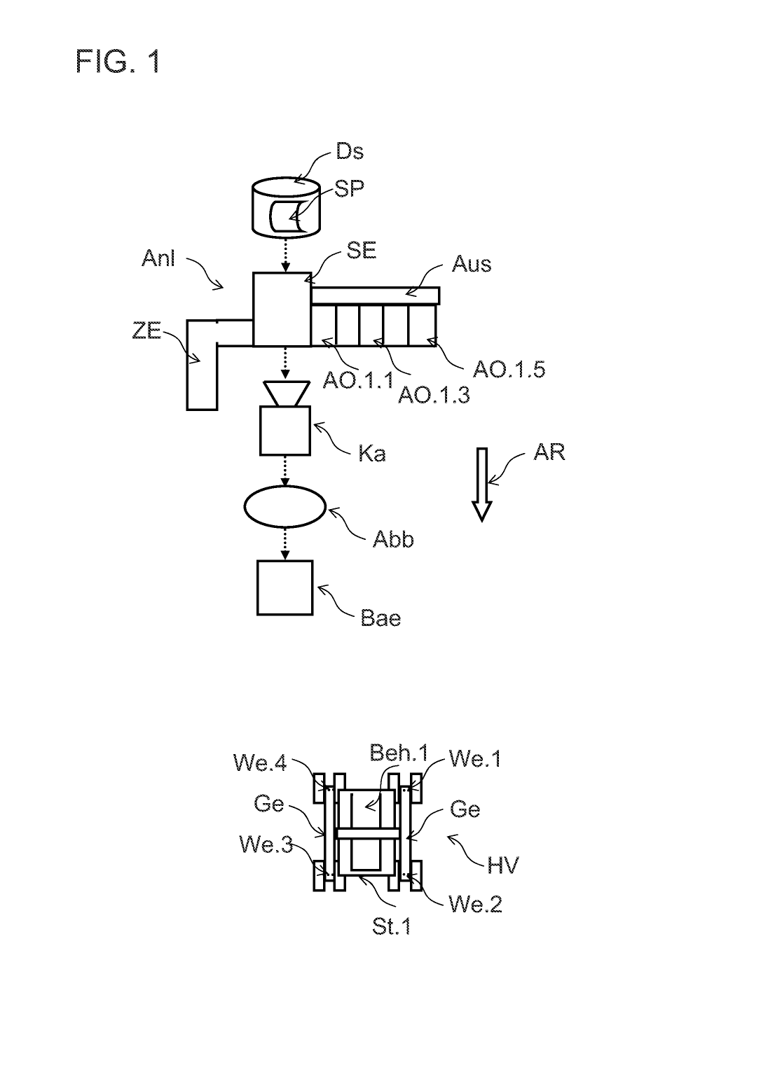

Referring now to the figures of the drawing in detail and first, particularly, to FIG. 1 thereof, there is shown the apparatus of the exemplary embodiment in top view with a sorting system Anl, a mobile holding device HV and four receiving units in the form of containers Beh.1, Beh.2, Beh.3, Beh.4. The container Beh.1 on the uppermost bay St.1 can be seen.

The sorting system Anl comprises
a feed device, or feeder ZE, having a singulator;
a measuring instrument in the form of a reader with a camera Ka and with an image evaluation unit Bae;
a sorting device, or sorter SE with a machine control system;
a discharge device Aus; and
a plurality of sorting end points AO.1.1, AO.1.2, . . . AO.4.5.

In the top view of FIG. 1, only the uppermost row AO.1.1, . . . AO.1.5 of sorting end points of the sorting system Anl can be seen.

The mail items to be sorted are fed in arbitrary apparatus to the feed device ZE. The singulator of the feed device ZE generates a stream of mutually adjacent and upright mail items. These isolated mail items are guided past the camera Ka. The camera Ka respectively generates at least one computer-available image Abb of that surface of each upright mail item which exhibits the addressee identification. The image evaluation unit Bae evaluates the image Abb and deciphers the addressee identification in the image. In the exemplary embodiment, this addressee identification acts as the sort feature value of this mail item.

The sorting device and the discharge device Aus apply a computer-available sorting plan SP, which is stored in a data store Ds of the sorting system Anl. This sorting plan SP assigns to each possible sort feature value (each addressee identification) respectively a sorting end point (discharge site) AO.1.1, AO.1.2, . . . of the sorting system Anl. Generally, the sorting plan SP assigns the same sorting end point to the plurality of different sort feature values, since there are many more possible addressee identifications than sorting end points.

By evaluating the sorting plan SP for each mail item, the discharge device Aus selects the respectively assigned sorting end point AO.1.1, AO.1.2, . . . and transports the mail item to this selected sorting end point. Which sorting end point AO.1.1, AO.1.2, . . . the discharge device selects thus depends on the addressee identification on the mail item and the computer-evaluable sorting plan SP.

In one embodiment, the mail item is transported upright to the sorting end point AO.1.1, AO.1.2, . . . . In another embodiment, the horizontal mail item is transported to the sorting end point AO.1.1, AO.1.2, . . . . In a third embodiment, the mail item, following isolation, is releasably connected to a holding component (holder), and the holding device with the mail item is transported to the selected sorting end point.

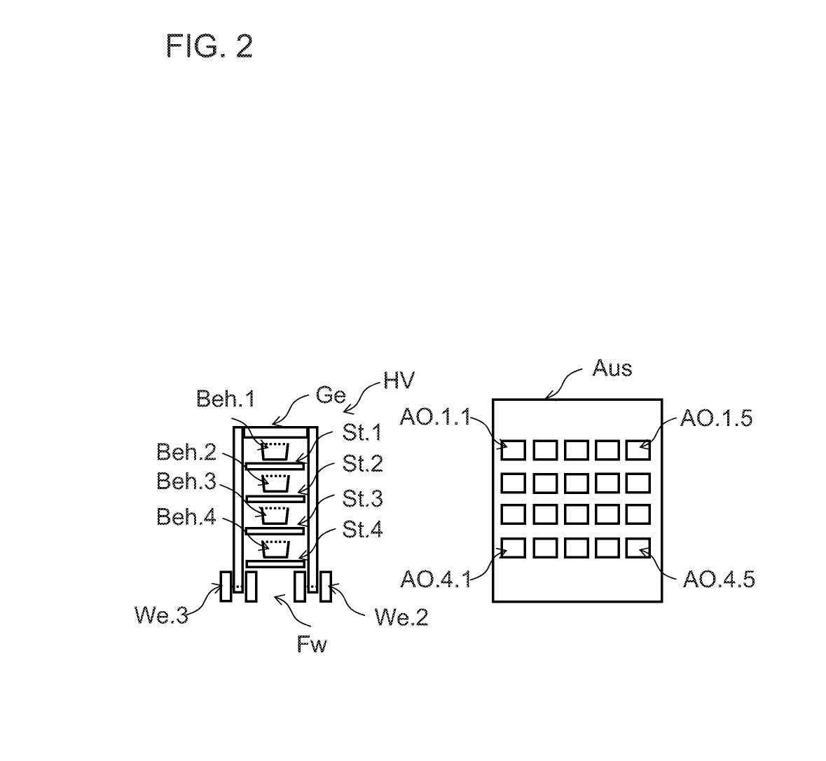

In the exemplary embodiment, the sorting end points AO.1.1, AO.1.2, . . . are arranged in a matrix comprising a plurality of rows and comprising one, or preferably more than one column(s). Because a plurality of sorting end points AO.1.1, AO.1.2, . . . are arranged one above the other, space is saved in comparison to sorting end points AO.1.1, AO.1.2, . . . in just a single row. FIG. 2 shows on the right, by way of example, an apparatus of 20 sorting end points in four rows of five sorting end points each (discharge sites). The sorting end point AO.i.j is found in row i and column j (i=1, . . . , 4; j=1, . . . , 5).

In one embodiment, each sorting end point AO.1.1, AO.1.2, . . . possesses a floor over which mail items can be horizontally displaced up to a container. In one embodiment, the floor is steeply inclined. It is possible for the floor to be formed by a continuous conveyor belt on which the mail items stand and which transports the mail items from the sorting end point AO.1.1, AO.1.2, . . . to the container. In another embodiment, each mail item is held during sorting by a holding component (“holder”) and is transported on this holding component to the sorting end point and into the container.

The sorting end points AO.1.1, AO.1.2, . . . AO.4.5 of the discharge device Aus act as discharge sites. The discharge device Aus discharges the mail items in containers Beh.1.1, Beh.1.2, . . . , as is described below. These containers act in the exemplary embodiment as the receiving units.

In the exemplary embodiment, each holding device HV possesses:
a rack Ge,
a running gear Fw having four shafts We.1, We.2, We.3, We.4, and
a plurality of bays St.1, St.2, St.3, St.4 for receiving units Beh.1, Beh.2, Beh.3, Beh.4, the bays St.1, St.2, St.3, St.4 being arranged vertically one above the other.

On each shaft We.1, We.2, . . . are respectively mounted two wheels, so that the holding device HV of the exemplary embodiment has eight wheels in all. In one modification, the running gear has four rotatable “bogies”. Each bogie respectively comprises two shafts and four wheels. In the exemplary embodiment, the mobile holding device HV possesses no drive of its own, but is moved by a worker or automatic handler.

The rack Ge has, for example, the shape of a U or two U's with downward pointing arms. The rack Ge is fixedly connected to the running gear Fw. The bays St.1, St.2, St.3, St.4 are located, for example, between the two arms of the U and are thus fixedly mounted. The holding device HV can be transported by means of the running gear FW over a floor. This rack Ge can be seen in FIG. 2 on the left. The rotational axes of the shafts We.3, We.4 lie in the plane of projection of FIG. 2.

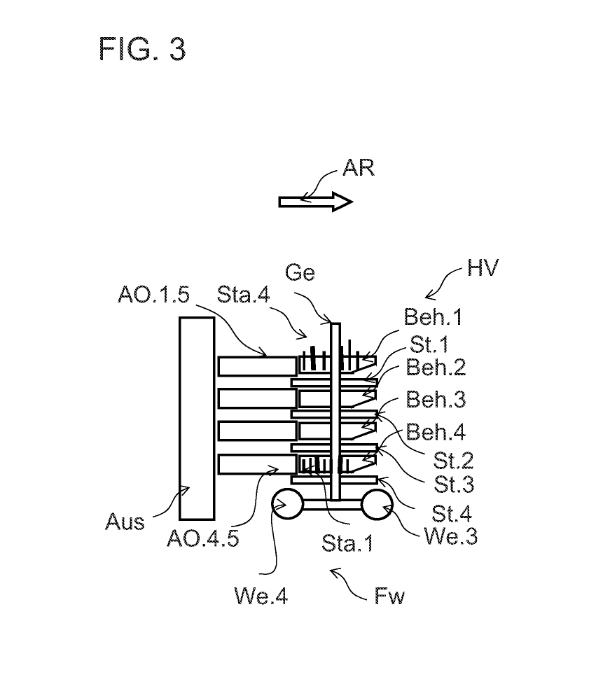

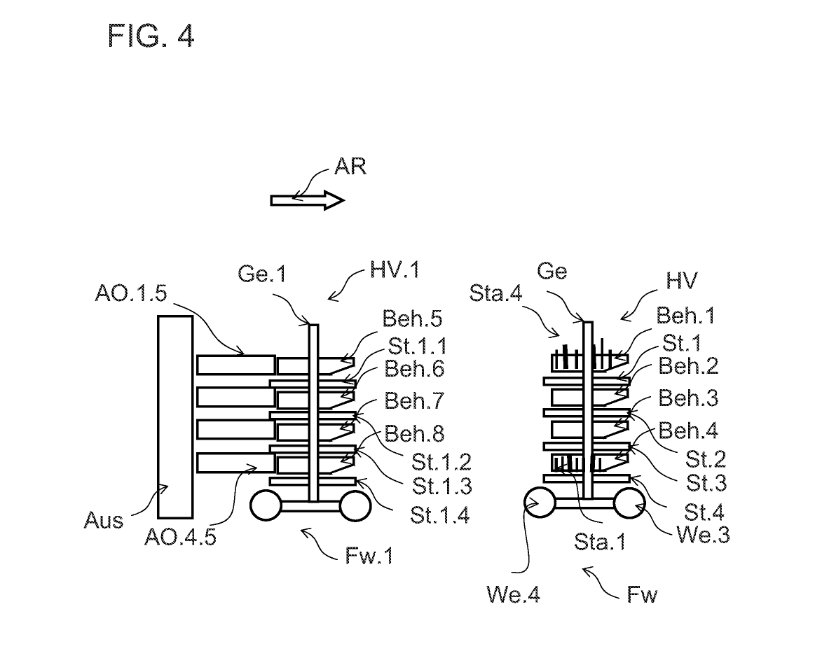

FIG. 3 shows the apparatus of FIG. 1 in side view with the holding device HV outside the discharge position. FIG. 4 shows the apparatus of FIG. 3 with the holding device HV in the discharge position and with a further holding device HV.1.

In the exemplary embodiment, each holding device respectively possesses four planes with bays. Each plane of the holding device comprises a bay, in the exemplary embodiment precisely one bay. The sorting end positions (discharge sites) are arranged in four rows. Row number i comprises the sorting end points AO.i.1, AO.i.2, . . . . To each row of the matrix of sorting end points there is assigned precisely one plane of each holding device. Hence, in the exemplary embodiment, to row no. i of the sorting end points matrix is assigned the bay St.i in plane no. i of the holding device HV (i=1, 2, . . . ).

In the exemplary embodiment, containers are used as receiving units. Each container Beh.1, Beh.2, Beh.3, Beh.4 has a bottom and at least three side walls. In another embodiment, the fourth side wall is missing. In another embodiment, the fourth side wall can be pivoted. In both embodiments, mail items can be transferred into the container Beh.1, Beh.2, Beh.3, Beh.4 by a horizontal linear movement. In another embodiment, each container possesses four fixedly arranged side walls. The bottom of the container is preferably rectangular. A side wall adjoins two other side walls. Each container Beh.1, Beh.2, . . . is upwardly open, so that mail items can also be loaded into the container from above and can be removed again from the container from above.

On each bay St.1, St.2, St.3, St.4 of the holding device HV, a container Beh.1, Beh.2, Beh.3, Beh.4 can respectively be placed. The bottom of each container Beh.1, Beh.2, Beh.3, Beh.4 rests on the respective bay St.1, St.2, St.3, St.4.

A receiving unit locking mechanism releasably locks the container on the bay and holds the container in a set position on the bay. For example, a locking body is displaced counter to the force of a spring when the container is placed onto the bay. The locking body engages in a slot in a side wall. Or the bottom of the container projects in a narrow strip beyond the side walls and the locking body presses against the narrow strip.

Each holding device HV can be transported into a discharge position with respect to a column of sorting end points AO.1.1, AO.1.2, . . . of the sorting system Anl. If the holding device HV is in the discharge position, then the receiving units Beh.1, Beh.2, Beh.3, Beh.4 on the bays St.1, St.2, St.3, St.4 of this holding device HV correspond with the sorting end points of a column of the above-mentioned matrix. The discharge device Aus thus discharges mail items directly into the containers Beh.1, Beh.2, . . . on the bays of the holding device HV. The discharge device Aus and the holding device HV are correspondingly matched to one another. In particular, the distance between two bays St.1, St.2, St.3, St.4 of the holding device HV which lie one above the other tallies with the distance between two sorting end points AO.1.1, AO.1.2, . . . which lie one above the other.

The bays St.1, St.2, . . . of the holding device HV and the matrix of the sorting end points AO.1.1, AO.1.2, . . . are matched to one another in such a way that the following is enabled: A container Beh.i standing on the bay St.i can be transferred into a position by a horizontal movement by the reception by the container Beh.i of those articles which the sorting system discharges into the associated sorting end point AO.i.j. (i=1, 2, . . . ). The horizontal movement of the container Beh.i is induced by the fact that the holding device HV St.i is transported with the bay to the sorting system Anl and is transferred into the discharge position with respect to the column j of sorting end points.

In one embodiment of the exemplary embodiment, at least just as many holding devices are used as the sorting system Anl has columns of sorting end points, or at least two holding devices more than the sorting system Anl has columns of sorting end points. Preferably, twice as many holding devices are used as the sorting system has columns of sorting end points. This embodiment enables a holding device with empty receiving units to be transferred into the discharge position with respect to a column of sorting end points, so that the discharge device fills the receiving units of the holding device, and at the same time enables the filled receiving units to be removed from a second holding device and empty receiving units to be placed onto the bays of this holding device.

In one embodiment, similar holding devices are used. Each holding device can be transferred into the discharge position with respect to each column of sorting end points. The sorting end points in a row are thus all similar. The distances between two bays arranged one above the other can be equal or can vary from plane to plane of the positioning truck. This spares the need to have to keep various holding devices in stock.

In another embodiment, different holding devices are used. Each holding device can be used for one or some of the columns of sorting end points, but not for each column. This embodiment allows the use of different sorting end points, for example sorting end points of different dimensions for different mail items. This embodiment is expediently combined with an embodiment in which the sorting system measures at least one dimension of each mail item and the discharge device Aus takes this dimension into account in the selection of a sorting end point AO.1.1, AO.1.2, . . . .

Preferably, each column of sorting end points AO.1.1, AO.1.2, . . . respectively has a holding device locking mechanism. This holding device locking mechanism locks the holding device HV releasably in the discharge position with respect to this column of sorting end points. For example, on the rack Ge, or on at least one bay or on each bay St.1, St.2, . . . of the holding device HV, there are arranged two protruding elements, which engage in corresponding slots on the column of sorting end points and form a locking body. This locking body locks by falling into the slot and can be guided back out of slot only counter to the force of a spring. Preferably, the holding device locking mechanism further comprises at least one stop, which delimits a movement of the holding device HV onto the discharge device Aus. The holding device HV is first transported onto the discharge device to the point where the at least one stop prevents a further movement, and is then locked in place by the holding device locking mechanism.

Preferably, each sorting end point AO.1.1, AO.1.2, . . . of the discharge device Aus has a discharge locking mechanism. This discharge locking mechanism locks either a bay St.1, St.2, . . . for a container Beh.1.1, Beh.1.2, . . . or the container Beh.1.1, Beh.1.2 itself, and thereby locks the container Beh.1.1, Beh.1.2, . . . releasably in a certain position with respect to the discharge device Aus when the container Beh.1.1, Beh.1.2, . . . stands on a bay St.1, St.2, . . . of the holding device HV and the holding device HV is in the discharge position.

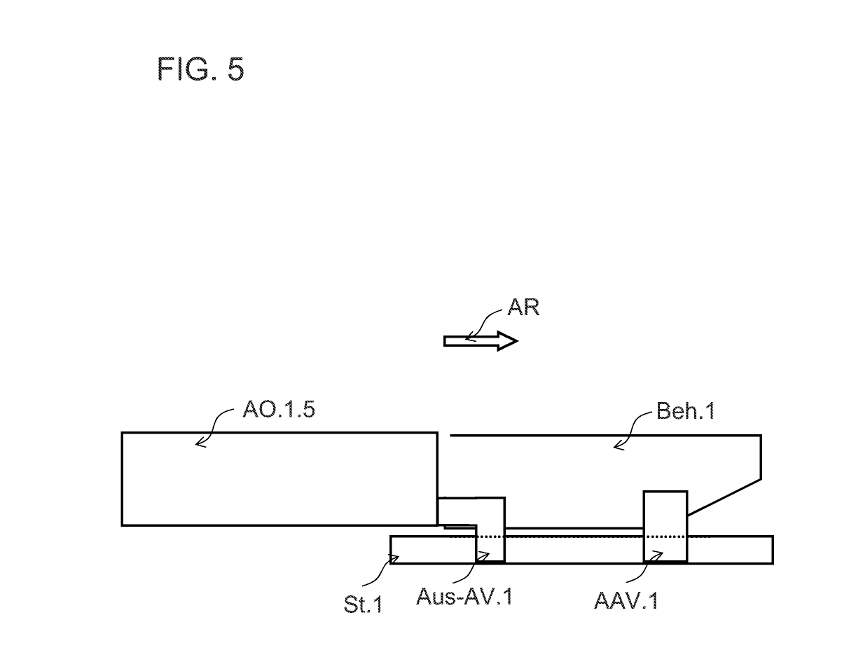

In FIG. 5, a discharge locking mechanism Aus-AV.1 with a locking body is shown on the bay St.1. The locking body is capable of engaging in a corresponding slot of the sorting end point AO.1.5. It is possible for the bay St.1 to have two locking bodies, between which the container Beh.1 is found. Other embodiments of the discharge locking mechanism are possible.

Preferably, the sorting system Anl generates a release signal as soon as a holding device HV is in the discharge position with respect to a column of sorting end points and the holding device locking mechanism has locked the holding device HV. This release signal clears this column of sorting end points and the discharge device Aus discharges mail items into the receiving units of this holding device HV. In one embodiment, the release signal is emitted acoustically and/or optically. If a holding device HV is pushed to a column without emission of the release signal, then the process of changing and adjusting the position of the holding device HV with respect to the column of sorting end points until the release signal is emitted is triggered.

In the example of FIG. 4, the holding device HV with filled containers Beh.1, Beh.2, Beh.3, Beh.4 has been transported away from the discharge position. The holding device HV.1 has been transferred into the discharge position. To the discharge site AO.i.5 are assigned both the bay ST.1.i of the further holding device HV.1 and the bay St.i of the holding device HV (i=1, . . . , 5).

In the example of FIG. 4, the holding device HV, on whose bays St.1, St. 2, St.3, St.4 stand filled containers Beh.1, Beh.2, Beh.3, Beh.4, has been moved away from the discharge position. In one embodiment, the containers Beh.1, Beh.2, Beh.3, Beh.4 are removed from the holding device HV and transported off to their respective destinations. In another embodiment, the holding device HV is transported together with the filled containers to the feed device ZE of the sorting system Anl. The containers Beh.1, Beh.2, Beh.3, Beh.4 are taken from the bays St.1, St.2, St.3, St.4. The mail items from these containers are removed from the containers Beh.1, Beh.2, Beh.3, Beh.4 and supplied once again to the feed device. In a second sorting run (“second pass”), the mail items pass once again through the sorting system. The sorter Se and the discharge device Aus apply a second sorting plan.

The following summarizes the reference symbols and numerals used in the specification:

| | |
|---|---|
| AAV.1 | Receiving unit locking mechanism, locks the |
| | container Beh.1 onto the bay St.1 |
| Abb | Computer-available image of the surface of a |
| | mail item, showing the addressee identification, |
| | is generated by the camera Ka |
| Anl | Sorting system |
| AO1.1, AO1.2, . . . | Discharge sites of the sorting system Anl |
| Aus | Discharge device of the sorting system Anl |
| Aus-AV.1 | Discharge locking mechanism for the logical |
| | discharge site AO.1 |
| Bae | Image evaluation unit of the reader of the |
| | sorting system Anl |
| Beh.1, Beh.2, . . . | Containers, acting as receiving units on |
| | bays St.1, St.2, . . . |
| Ds | Data store with the sorting plan SP |
| Fw | Running gear of the holding device HV |
| Ge | Rack of the holding device HV |
| HV | Holding device with rack Ge, running gear Fw |
| | and bays St.1, St.2, . . . |
| Ka | Camera of the reader of the sorting system Anl |
| RAV | Holding device locking mechanism |
| SE | Sorting device of the sorting system Anl |
| SP | Computer-available sorting plan stored in data |
| | memory Ds |
| St.1, St.2, . . . | Bays of the holding device HV, respectively |
| | receiving a container Beh.1, Beh.2, . . . |
| We.1, We.2, . . . | Shafts of the running gear Fw of the holding |
| | device HV, respectively bearing two wheels |
| ZE | Feed device, feeder |

1. An apparatus for sorting stackable articles in accordance with a predefined sort feature, the apparatus comprising:
a sorting system including a measuring instrument and a discharge device, said discharge device having at least two discharge sites, said measuring instrument being configured to measure, for each of the stackable articles to be sorted, a value which the sort feature assumes for the article;
at least two receiving units;
at least one movable holding device including a rack and at least two bays each configured to receive a respective said receiving unit, and said holding device being movable into a discharge position with respect to said discharge device;
each said receiving unit being configured to receive a respective stack of articles to be sorted;
each said discharge site of said discharge device having a corresponding bay of each said holding device assigned thereto;
said discharge device being configured to select for each article to be sorted, in dependence on the sort feature value measured for the article, in each case precisely one said discharge site, and to respectively generate in each said receiving unit a stack of articles to be sorted;
said discharge device further being configured to then transport each article to be sorted to the selected discharge site and discharge the article from the selected discharge site directly into a given receiving unit, when said receiving unit, in the course of the discharge, is received by a bay of said holding device, with said holding device being in the discharge position, so that a stack of articles is respectively generated in each said receiving unit;
wherein said receiving bay is the corresponding said bay assigned to said discharge site selected by said discharge device for the respective article;
whereupon said holding device is transferred into the removal position such that said receiving units may be taken from said bays of said holding device located in the removal position.

2. The apparatus according to claim 1, wherein at least one bay of each said holding device has a receiving unit locking mechanism configured to releasably lock a receiving unit on said bay in a set position with respect to said bay.

3. The apparatus according to claim 1, which further comprises a holding device locking mechanism configured to releasably lock said holding device in the discharge position.

4. The apparatus according to claim 1, wherein each article to be sorted is discharged, by a linear movement, from the selected said discharge site into said receiving unit on the corresponding said bay.

5. The apparatus according to claim 1, wherein said at least two bays of each said holding device are arranged vertically one above the other.

6. The apparatus according to claim 1, wherein at least one movable holding device is configured as a mobile holding device formed with a rack having a running gear.

7. A sorting method for sorting articles in accordance with a predefined sort feature, the method which comprises:
providing a sorting system, at least two receiving units, and at least one movable holding device;
the sorting system having a discharge device with at least two discharge sites;
each holding device respectively having at least two bays;
wherein each discharge site of the discharge device has a respectively assigned corresponding bay of each holding device;
performing a holding device loading step, after which step each bay of the holding device respectively receives a receiving unit;
moving the holding device together with the receiving units to the sorting system;
transferring the holding device into a discharge position with respect to the discharge device;
the sorting system performing the following steps, for each article:
measuring a value which the predefined sort feature assumes for the article; and
discharging the article, in dependence on the measured sort feature value, into a receiving unit;
the discharge device performing the following steps, for each article to be sorted:
in dependence on the measured sort feature value of the article, selecting precisely one discharge site; and
transporting the article to the selected discharge site and discharging the article into a receiving unit;
when
the holding device is in the discharge position and
the receiving unit into which the article is discharged, upon discharge, is received by that corresponding bay of the holding device in the discharge position that is assigned to that discharge site which the discharge device has selected for the discharged article;
in order to generate a stack of articles in each receiving unit, and transferring the holding device together with the filled receiving units away from the sorting system into a removal position; and
taking the filled receiving units from the bays of the holding device located in the removal position.

8. The sorting method according to claim 7, which comprises:
using two holding devices and performing the two steps with a chronological overlap, and thereby
discharging articles with the sorting system into the receiving units on the bays of one holding device while one holding device is in the discharge position; and
replacing the filled receiving units on the bays of the other holding device with empty receiving units.
